(19) United States
(12) Patent Application Publication
(10) Pub. No.: US 2009/0195864 A1
(43) Pub. Date: Aug. 6, 2009

(54) PARTIALLY TRANSPARENT STATIC SUN PROTECTION DEVICE

(75) Inventors: Tilmann Kuhn, Hinterzarten (DE); Michael Hermann, Freiburg (DE)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: FRAUNOFER-GERSELLSCHAFT ZUR FORDERUNG DE ANGEWANDT E.V., MUNCHEN (DE)

(21) Appl. No.: 12/306,046

(22) PCT Filed: Jun. 29, 2007
(86) PCT No.: PCT/DE07/01156

§ 371 Date: Dec. 22, 2008

(30) Foreign Application Priority Data
Jun. 30, 2006 (DE) 10-2006-030-244.3

(51) Int. Cl. G06K 7/10; G02B 17/00; G02B 27/00

(52) U.S. Cl. 359/350; 359/591; 359/596

(57) ABSTRACT

The present invention relates to a part-transparent static sun protection device of a flat base (1) which consists of a material that is impermeable to solar radiation and/or coated with a material of that type. The base comprises permeable openings (4, 10, 13) with an angle-selective permeability for the sunlight, wherein a maximum of the permeability lies at an angle of incidence of ≠90° of the sunlight relative to the plane of the base (1). The openings, (4, 10, 13) with the present sun protection device are introduced in the base (1) through mere local machining. The proposed sun protection device can be easily adapted to the most varied requirements during manufacture.

The invention relates to a partially transparent static sun protection device from a flat base that consists of a material which is impermeable to solar radiation and/or is coated with material of that type and has permeable openings with an angle-selective permeability for the sunlight, wherein a maximum of the permeability is at an angle of incidence of ≠90° of the sunlight in relation to the plane of the base.

In facade construction—more preferably in the case of office buildings—the proportion of glazed surfaces has continuously risen in recent years. However, in addition to the positive effect of greater daylight supply this can also lead to overheating of the office space which is why adequate sun protection must be provided. This sun protection on the one hand should allow at least partial vision to the outside and result in good room illumination but on the other hand provide adequate sun protection and avoid glare.

### PRIOR ART

In addition to flexible, adjustable designs of sun protection devices such as louvers or textile roller blinds there also exist fixed or moveable hangings. DE 101 611 59 A1 and DE 101 395 83 A1 show sun protection devices which are constructed of a parallel arrangement of horizontal metal bars whose cross-sectional geometry is optimised in terms of directing the light. Through-vision is made possible at the same time through a gap between the bars.

Laminated glass panes, into which expanded metal with permeable slots is laminated, are commercially available. The permeable slots are created through expanding deformation of a metal plate into which corresponding cuts have previously been made. Such a sun protection device is briefly mentioned for example also in U.S. Pat. No. 3,453,039 in connection with the FIGS. 3 and 4 of this publication, which deals with a sun protection device without permeable openings. The enforced parallel arrangement of the opened slots in the sun protection device however restricts a sun protection device of this type to greatly defined applications. Furthermore, during the expansion process, the entire plate is subjected to tensile load so that no additional elements can be attached to the plate prior to the deformation.

The object of the present invention consists in stating a sun protection device which during the manufacture can be adapted to various applications without major effort and makes possible the attachment or integration of additional elements such as for example solar absorber tubes, even at the starting stage of manufacture.

### PRESENTATION OF THE INVENTION

The object is solved with the sun protection device according to Patent claim 1. Advantageous configurations of this solar protection device are the subject of the subclaims or can be taken from the following description as well as the exemplary embodiments.

The proposed static sun protection device consists of a flat base which consists of a material that is impermeable to solar radiation and/or coated with a material of that kind and has permeable openings with an angle-selective permeability for the sunlight, wherein a maximum of the permeability lies at an angle of incidence of ≠90° of the sunlight in relation to the plane of the base. The openings in the present sun protection device are introduced through mere local machining so that through the generation of the openings the remaining regions of the base are not subjected to any stress or load. Here, the openings can have any geometry for example circular or slot-shaped. The base itself preferentially consists of a flat or curved plate of metal or plastic.

The openings in a development can be introduced into the base through local removal of material of the base, for example by means of punching out, cutting out or drilling. Suitable techniques are laser cutting, laser drilling or water jet cutting.

In another configuration the openings are formed through locally bent-out regions of the base. During the manufacture the base is suitably cut in for this purpose so that the openings can be created by bending out regions of the base. The bent-out regions which as a rule are embodied strap-shaped remain joined to the base and serve for the guidance of the light.

The present static sun protection device is thus characterized by openings which are introduced into the base through mere local machining and thus do not influence the remaining material of the base during the manufacture. The angle-selectivity of these permeable openings during the manufacture can be selected largely freely so that the sun protection device can be manufactured for a wide range of applications or requirements without major effort. More preferably, openings of various designs can also be present in various sections of the base.

The proposed static sun protection device can also comprise two or more transparent coverings at the front and back so that it can be used as glazing, window or facade element. Here, the base is installed between the coverings or glass panes utilizing the usual manufacturing technologies of window and facade construction. Through the specially formed openings the desired sun protection, vision, anti-glare and daylight supply requirements are fulfilled.

In many cases, more preferably when using the sun protection device as facade element, it is advantageous for optical reasons if the side of the base facing the sun has a different colour than the side facing away from the sun. The different colour can for example be obtained through different painting of both sides. Preferentially the side of the base facing away from the sun is embodied IR-reflective, for example metallic or through coating with an IR-reflecting paint.

The sun protection device is suitable with particular advantage for the use in the balustrade region of buildings since with appropriate configuration it also offers the possibility of vision in an inclined downward direction. This relates especially to balustrade regions of full glass facades or balcony balustrades both in residential as well as non-residential construction. The present sun protection device can be advantageously employed for all facade regions which are glazed, preferably for such regions which do not directly serve for outward vision. Examples of this are horizontal roof skylights, inclined facade or roof elements as well as generally the skylight region and the balustrade region of a facade.

In a configuration of the present sun protection device the openings are formed through local cutting-in of the base and bending-open of strap-shaped regions created through the cutting-in. Here, the bent-open regions remain joined to the base so that via their bending angle or inclination, various effects of light permeability are achieved. For instance with a vertically standing base the strap-shaped regions can be bent for example upwards or downwards. Obviously the base has to be differently cut in for this purpose. An opening can be obtained through the bending-out of a plurality of regions. An opening for example with a strap-shaped region bent upwards and a strap-shaped region bent downwards offers almost any adjustability of the relationships of sun protection, vision, anti-glare effect and daylight supply via the bending angles.

In an advantageous configuration a plate obtained through rollbonding is employed as base which comprises non-welded regions which are locally cut open and bent open for forming the openings. In this manner, with identical opening diameters, longer bent-out regions with respect to the bending direction are then obtained with a simple plate so that the sun protection effect can still be increased because of this.

In a very advantageous configuration of the present sun protection device the openings are formed as slots or grooves with a wedge-shaped cross-sectional profile. The slots can be orientated vertically, horizontally or even obliquely so that the sun is faded out as best as possible. At least one of the two side walls of the wedge-shaped slots does not follow a course that is vertical to the plane of the base or to its surface but at an angle of <90°. Via the selection of the angles of the two side walls and the clear width of the slot vertically to the slot direction, in the following also designated as gap width, and the thickness of the base the sun protection effect as well as the through-vision angle, the anti-glare effect and the daylight supply can be deliberately set here as well.

With a further advantageous configuration of the present sun protection device the openings are formed as bores whose central axis runs at an angle of ≠90° in relation to the plane of the base or to its surface. Via the angle of the central axis of the bores, the diameter of the bores and the thickness of the base the effects of the sun protection can be specifically set for the respective application. Here, it is also possible that at least some of the bores do not run parallel to one another.

### BRIEF DESCRIPTION OF THE DRAWINGS

The present sun protection device is once more briefly explained in the following by means of exemplary embodiments in connection with the drawings.

Here it shows:

FIG. 1 an example of an opening created through bending-open with a configuration of the sun protection device;

FIG. 2 four examples of the effect of bent-out elements with a configuration of the present sun protection device;

FIG. 3 preferred angular ranges with the bending-open of the strap-shaped elements;

FIG. 4 an example of the use of a rollbond plate as base;

FIG. 5 a further example of an opening created through turning;

FIG. 6 an example of a configuration of the present sun protection device with wedge-shaped slots as openings;

FIG. 7 an example of a configuration of the sun protection device with circular bores as openings;

FIG. 8 an example of the use of the sun protection device as balcony balustrade;

FIG. 9 an example of a configuration of the sun protection device with absorber channels; and

FIG. 10 a further example of a configuration of the sun protection device with absorber channels.

### WAYS OF CARRYING OUT THE INVENTION

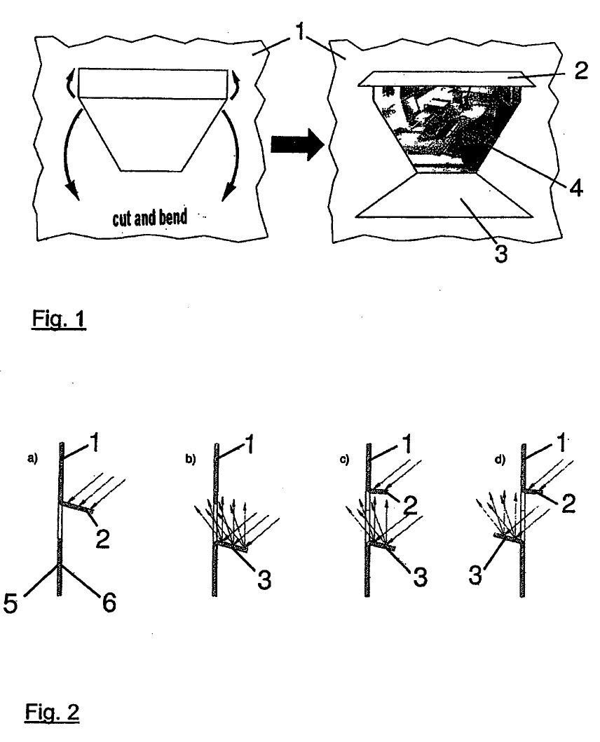

FIGS. 1 to 5 show examples of the configuration of the openings in the base with a configuration version of the present sun protection device wherein the openings are obtained through cutting-in of the base and bending-open of the strap-shaped regions or elements created by this.

Here, FIG. 1 shows the principle of the cutting and bending-out of the openings by means of an example. The plate 1 employed as base in this example is cut in the appropriate position of the opening as is shown in the left part of the Figure. The strap-shaped elements 2, 3 created by this are bent out upwards or downwards so that the opening 4 visible in the right part of the Figure is created in plate 1 which is limited by the two bent-out elements 2 and 3 at the top and bottom.

FIG. 2 shows various versions during the bending of the strap-shaped elements which result in different effects in sun protection. All four of the shown versions have in common that they were created from a plate 1 through bending-out of the strap-shaped elements following the cutting-in of a corresponding structure in the plate 1. The orientation of the elements in this case can be horizontal, vertical or even oblique. When using the sun protection device on a south-west facade an oblique arrangement for example offers the greatest advantage in order to fade out the sun as best as possible. The extent to which the structures have to be rotated from the horizontal can for example be taken from the publication by W Lorenz “A glazing unit for solar control, daylighting and energy conservation”, Solar Energy 70 (2001) No. 2, PP 109-130, more preferably the FIG. 2 of the this publication. In the following, a horizontal arrangement of the bent-out elements is assumed for illustration.

In the example of FIG. 2a the strap-shaped element 2 is bent out towards the top. The angle δ relative to the vertical in this case should be in the range between 0° and 90°, preferably in the range between 10° and 60° and particularly preferably at δ=40°. In the example of FIG. 2 the current direction of the solar radiation which is incident obliquely from the front is marked with the arrows. The configuration of FIG. 2a allows through-vision in horizontal direction as well as in downward direction with simultaneous protection from direct solar radiation. With this as well as the other versions of FIG. 2 the inner surface 5 of the base is embodied light-grey while the outer surface is provided with a coating 6 reflecting the solar radiation.

The example of FIG. 2a shows a version wherein the strap-shaped element 3 is bent out in a downward direction. The bending angle ε relative to the horizontal in this case is within the range between −20° and +270°, preferably in the range between 0° and 90° or between 180° and 270°. When directing the light has the highest priority, an angle of −20°≦ε<45° or −160°≦ε≦225° is preferred. When anti-glare and solar protection have the highest priority an angle of 45°≦ε≦90° or 225°<ε<270°.

The bending-out of strap-shaped elements in the upward and downward directions can also be combined as is shown in the FIGS. 2c and 2d. Depending on the bending angle and bending direction, different effects can be achieved by doing so. The following Table shows the effects that are achieved with the four versions of the FIGS. 2a to 2d. Here, a “+” indicates that the respective effect is easily achieved, a “−” indicates that the respective effect is not easily achieved and a “0” indicates that the respective effect is partially achieved.

| | a) | b) | c) | d) |
|---|---|---|---|---|
| Absorption | + | − | 0 | + |
| Through-vision | + | 0 | 0 | 0 |
| Room illumination | − | + | + | 0 |
| Anti-glare | + | − | 0 | + |
| protection | | | | |
| Solar protection | + | − | 0 | + |

FIG. 4 shows an example wherein a plate obtained through rollbonding, a so-called rollbond plate 7 is used as base. With such a plate, non-welded regions are present which are blown up into channels 7 by means of compressed air as is schematically shown in the upper part of FIG. 4. By cutting-in and bending-open of such regions, substantially longer strap-shaped elements 2, 3 are obtained with the same opening diameter compared with a simple plate, by means of which the sun can be better faded out. The sharp outer edge of these elements is highly advantageous for the sake of anti-glare protection since no highlights can develop at this point. Fundamentally, better room illumination is achieved through the diffuse reflection of the sunlight on the elements 3 bent in the downward direction.

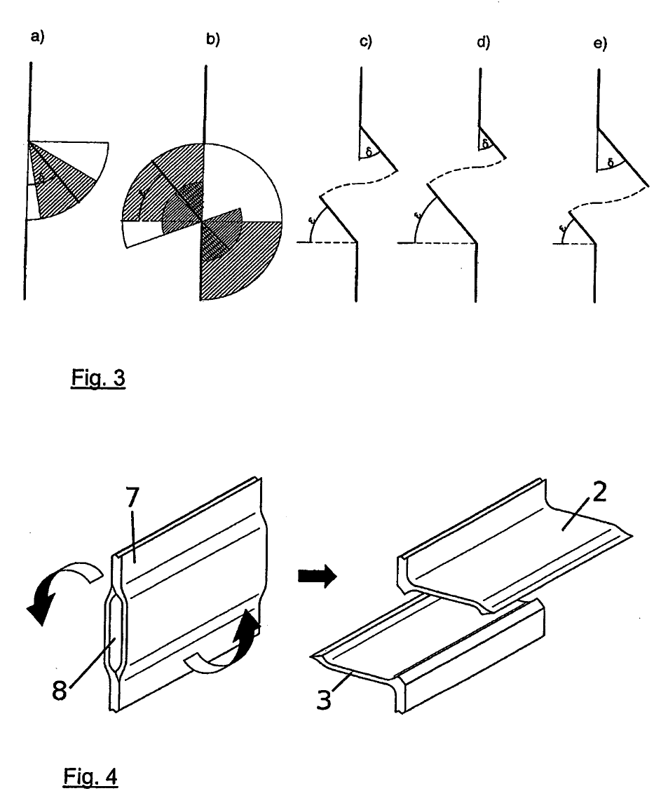

FIG. 3 shows the angles δ and ε in the FIGS. 3a to 3e as well as their preferred ranges. Within the total range shown in each case there is a preferred range which is indicated in simple hatch. The particularly preferred range for the light deflection is shown highly hatched, the particularly preferred range for anti-glare and solar protection in crossed hatch.

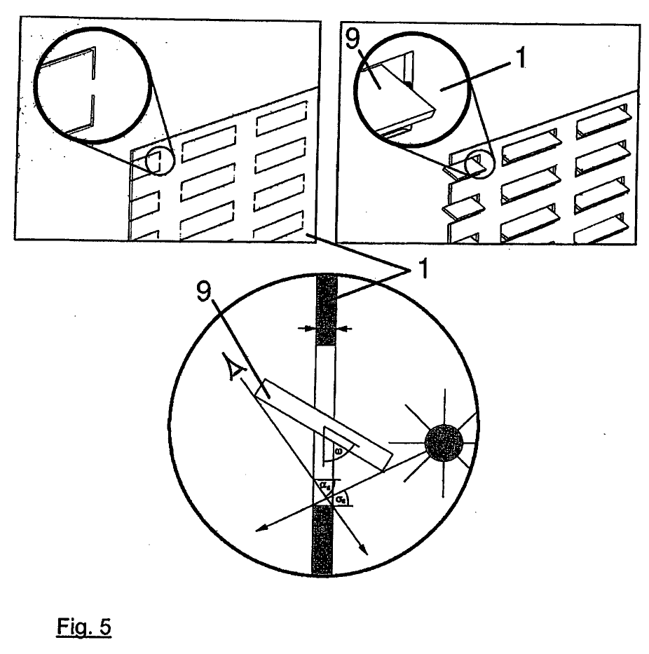

FIG. 5 shows a further example of openings which were created through bending-open of cut-in plate regions. In this case the plate 1 was cut in U-shaped on both sides of an opening axis as is evident in the upper part of the Figure, so that the strap-shaped elements can be turned out like a lamella 9. This is also illustrated in cross section in FIG. 5. In this way lamellae 9 similar to a louver are obtained. A plurality of lamellae 9 can also be arranged directly below one another. The following applies to the angular range σ_{E}: 0°≦σ_{E}≦80° preferably 0°≦σ_{E}≦45°, particularly preferred 5°≦σ_{E}≦25°.

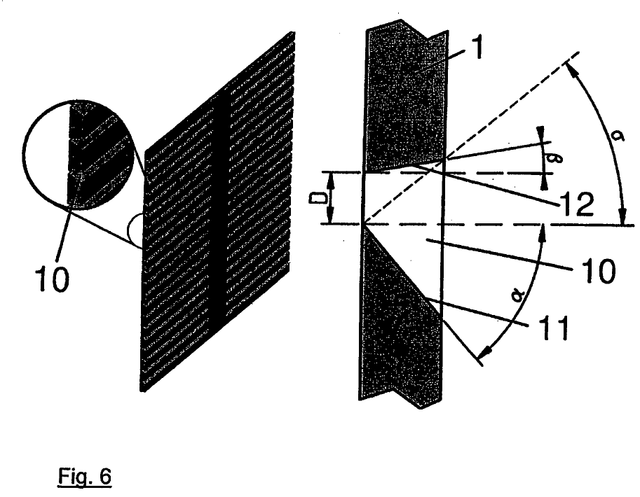

FIG. 6 shows a further possibility of the configuration of the present sun protection device wherein the angle-selective solar protection structure is not formed through the bending-out of plate elements, but through the cutting-out of wedge-shaped longitudinal grooves 10. This can for example take place by means of laser cutting. The grooves 10 can follow a vertical, horizontal or oblique course so that the sun is faded out as best as possible. On a southwest facade an oblique arrangement is advantageous (see publication by W. Lorenz in the place cited). Furthermore, horizontal grooves are assumed for the illustration. Here, the lower side wall 11 of the groove 10 is bevelled in the direction of the outside and downward in order to make possible through-vision in the downward direction. The angles α and β are measured in relation to the horizontal. σ is the fade-out angle for the sun. The angle α preferentially amounts to between 0° and 85°, the angle β, which indicates the inclination of the upper side wall 12 in relation to the horizontal, preferentially between −20° and +10°.

As a rule, the anti-glare requirements and the through-vision in the direction of the outside have higher priority than the daylight supply of the room. Interfering reflexes should therefore be avoided in any case. The lower side wall 11 should therefore be generally rotated from the horizontal steeper than 45° (α≧45°), so that horizontally incident sunlight is not deflected towards the inside, but towards the top. Light with a greater angle of incidence is then likewise reflected towards the outside since the angle of incidence is equal to the angle of reflection. The angular details for α apply regardless of the inclination of the facade on which the sun protection device is mounted. These are derived only from the possible positions of the sun.

If the daylight supply has a higher priority for example in the upper segment of a window band or above head height, the light should be reflected into the room (i.e. α<45°). This angular data for α also applies independently of the inclination of the facade but is derived from the possible solar positions at the respective place of attachment.

The upper side wall 12 in an advantageous manner should be inclined by the angle β in the upward direction in relation to the horizontal so that the direct sun is unable for most of the time to shine into the room in a grazing manner along the surface (−20°≦β≦10°). Particularly preferably the angle β is selected so that the following applies: −10°≦β≦0°. Although versions with |β|>10° are likewise possible, these are however degraded embodiments. The angular data for β applies independently of the inclination of the facade. It is derived only from the possible solar positions.

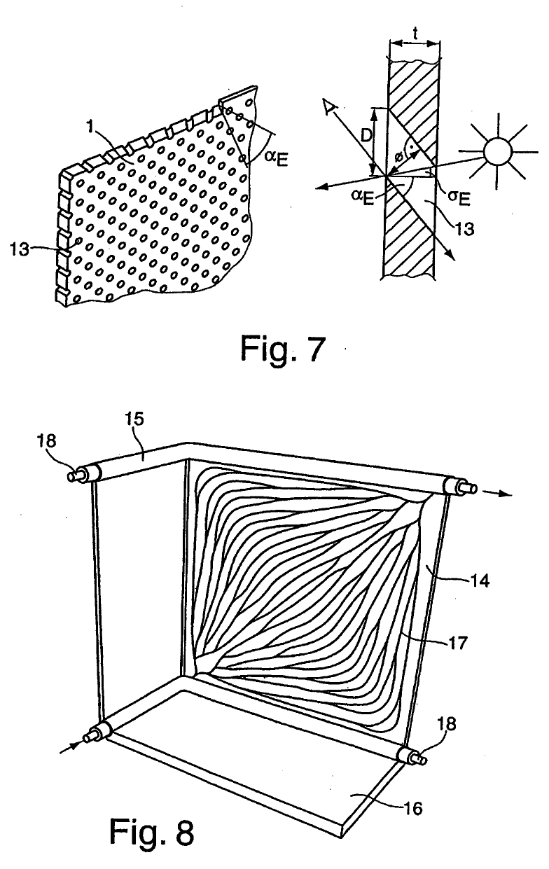

A further parameter for setting the anti-glare effect is the gap width D, which indicates the clear width on the inside of the groove 10. D thus determines the solar profile angle αₚ=σ from which the sun can directly shine through the grooves or gap in the base. The profile angle is the projection of the solar elevation angle on a vertical plane which stands perpendicularly in relation to the base. With a facade azimuth=solar azimuth, the profile angle corresponds to the elevation angle of the sun. The determination of the gap width can thus take place in this special case as is illustrated for example also in FIG. 7 in the right part figure. The gap width should be selected independently of the inclination of the facade so that the direct sun is faded out from a profile angle of −20°≦αₚ=σ≦70° preferably 0°≦σₚ=σ≦45° and particularly preferred 5°≦αₚ=σ≦25°.

FIG. 7 shows a further example of the present sun protection device wherein the opening is formed through obliquely drilled holes 13. These holes 13 can for example be created with a laser. The holes 13 advantageously face obliquely downward to the outside in order to make possible through-vision in this direction.

If anti-glare protection is a high requirement, it is practical to initially produce the holes 13 in the base 1 and then coat the base 1 matt black, so that the wall of the bore or the hole 13 shone upon by the sun is likewise coated. The following applies with the angles defined in the right part of FIG. 7: ø=t*cos(α_{E})*(tan(α_{E})+(tan(σ_{E})). With a given plate thickness t or thickness of the base and desired angles α and σ the necessary hole ø is thus obtained.

It is practical in many cases if the holes 13 are not parallel so that a certain transparency exists also laterally. The directions of the central axes of the holes 13 should in an advantageous manner all be included in a plane which is rotated in a downward direction by the angle α_{E} and has a horizontal intersection line with a base (see FIG. 7).

The angular ranges for α_{E} stated below are valid even with non-vertical facades (for example with roof windows), for α_{E} is only derived from the solar position and not from the inclination of the facade. Thus, α_{E} is defined in relation to the horizontal, independent of the inclination of the base. In the case of facades which are not south orientated it is advantageous if the centre line is not horizontal with the base but inclined, so that the sun is faded out as best as possible.

The following applies to the angular range of σ_{E}: −20°≦σ_{E}≦80° preferably 0°≦σ_{E}≦45° particularly preferred 5°≦σ_{E}≦25°.

The following applies to the angular range of α_{E}: 0°≦α_{E}≦85°. If high anti-glare protection requirements exist, α_{E} preferentially is >45° because directly incident radiation is then reflected upwards to the outside. Horizontally incident radiation is reflected vertically upwards at α_{E}=45°. As a rule there are high anti-glare protection requirements since through-vision can also be degraded through scattered light.

If no high anti-glare protection requirements exist and daylight utilization is important, the angle α_{E} is at <45°, since direct radiation incident from the outside then tends to be directed to the inside to the ceiling. The smaller α_{E} the more light is directed to the inside.

FIG. 8 shows an example wherein the proposed sun protection device is employed as balcony balustrade. In the figure, the sun protection device 14 can be seen which is mounted between the handrail 15 and the floor plate 16 of the balcony. Here, the openings are formed so that through-vision obliquely downwards is made possible but permeability for the sunlight above a solar angle of 25° is prevented. In the configuration of FIG. 8 additional absorber tubes 17 are fastened to the sun protection device or integrated in said sun protection device, which tubes are connected to the manifold channels 18 for the return and the advance. In this manner, the solar energy absorbed by the sun protection device can be given off as heat energy to a heat transfer medium which flows through the absorber tubes.

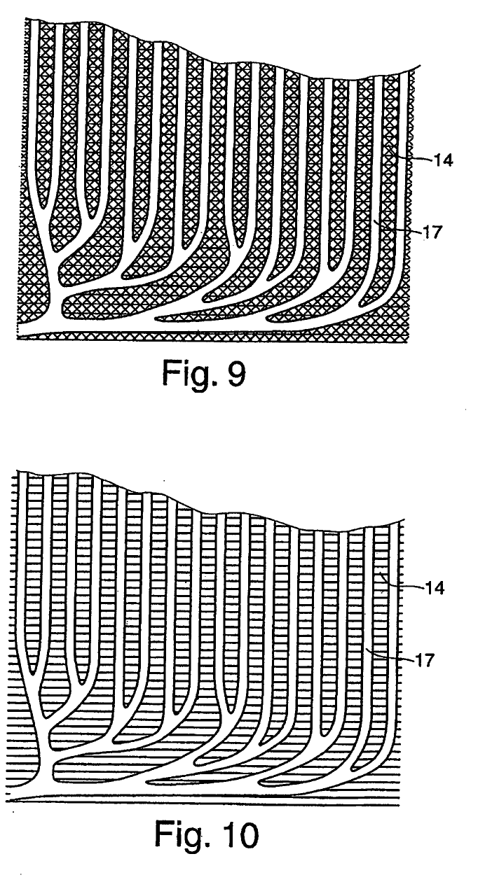

FIGS. 9 and 10 show two similar configurations wherein the sun protection device 14 likewise comprises absorber tubes 17. The configuration of FIG. 9 in this case shows the optical impression for the case of trapezoidal openings, the configuration of FIG. 10 the optical impression with fine slots as openings.

### LIST OF REFERENCE NUMBERS

1 Plate
2 Upper strap-shaped element
3 Lower strap-shaped element
4 Opening
5 Matt light-grey inner surface
6 Reflective coating
7 Rollbond plate
8 Channel
9 Lamella
10 Wedge-shaped grooves
11 Lower side wall
12 Upper side wall
13 Holes
14 Sun protection device
15 Hand rail
16 Floor plate
17 Absorber tubes
18 Manifold channels

1. A static sun protection device of a flat base (1), which consists of a material that is impermeable to solar radiation or coated with a material of that type and comprises permeable openings (4, 10, 13) with an angle-selective permeability for the sunlight, wherein a maximum of the permeability lies at an angle of incidence of ≠90° of the sunlight relative to the plane of the base (1), characterized in that the openings (4, 10, 13) are introduced into the base (1) by mere local machining.

2. The sun protection device according to claim 1, characterized in that the openings (4, 10, 13) are obtained through local removal of material of the base (1).

3. The sun protection device according to claim 2, characterized in that the openings (4, 10, 13) are slots with a wedge-shaped cross-sectional profile wherein at least one side wall (11, 12) does not follow a vertical course relative to a surface of the base (1).

4. The sun protection device according to claim 2, characterized in that the openings (4, 10, 13) are bores with central axes, which do not follow a vertical course relative to a surface of the base (1).

5. The sun protection device according to claim 1, characterized in that the openings (4, 10, 13) are obtained through local cutting-in of the base (1) and bending-open of strap-shaped regions (2, 3) created through this.

6. The sun protection device according to claim 5, characterized in that at least one of the strap-shaped regions (2, 3) of an opening (4, 10, 13) does not stand perpendicularly relative to a surface of the base (1).

7. The sun protection device according to claims 5 or 6, characterized in that the base (1) is formed of a plate (7) produced by means of rollbonding with non-welded regions, wherein some of the non-welded regions are locally cut open and bent open in order to form the openings (4, 10, 13).

8. The sun protection device according to claim 5, characterized in that at least some of the strap-shaped regions (2, 3) are bent out towards a first lateral edge of the base (1) by an angle which lies between 5° and 90°, preferentially between 10° and 50°, relative to the plane of the base (1).

9. The sun protection device according to claim 5, characterized in that with vertical positioning of the base (1) at least some of the strap-shaped regions (2, 3) are bent out upwards by an angle which is selected in such a manner that in an intersection of the openings (4, 10, 13) concerned with a vertical plane perpendicularly to the base (1) a straight-line connecting line between a lower edge of the opening (4, 10, 13) on a side of the base (1) and an upper edge of the opening (4, 10, 13) on an opposite side of the base (1) stands at an angle to the normal on the base (1) which is between 0° and 45°, preferentially between 5° and 25°.

10. The sun protection device according to claim 5, characterized in that at least some of the strap-shaped regions (2, 3) are bent out towards a second lateral edge of the base (1) by an angle which is between −20° and 270° relative to the perpendicular on the plane of the base (1).

11. The sun protection device according to claim 10, characterized in that (1) the angle, by which the strap-shaped regions (2, 3) are bent out towards the second lateral edge of the base (1) is in the range between 0° and 90° or between 18° and 270° or between −20° and +45° or between 160° and 225° or between 45° and 90° or between 225° and 270°.

12. The sun protection device according to claim 11, characterized in that the second lateral edge is located opposite the first lateral edge or constitutes a lower lateral edge of the base, wherein for at least some of the openings (4, 10, 13) a first strap-shaped region (2, 3) is bent out to the first lateral edge or to the top and a second strap-shaped region (2, 3) to the second lateral edge.

13. The sun protection device according to claim 3, characterized in that at least with some of the slots a first side wall (11) follows a course at an angle of ≧45° or at an angle of <45° to the perpendicular on the plane of the base (1).

14. (canceled)

15. The sun protection device according to claim 13, characterized in that a second side wall (12) follows a course at an angle between −10° and 0° to the perpendicular on the plane of the base (1).

16. The sun protection device according to claim 3, characterized in that with vertical positioning of the base (1) angles, by which an upper side wall (12) and a lower side wall (11) follow a course to the normal on the plane of the base (1) are selected in such a manner that in an intersection of the slots concerned with a vertical plane perpendicularly to the base (1) and to a slot longitudinal direction a straight-line connection line between a lower edge of the slot on a side of the base (1) and an upper edge of the slot on an opposite side of the base stands at an angle to the normal on the base (1), which is between 0° and 45°, preferentially between 5° and 25°.

17. The sun protection device according to claim 3 characterized in that a gap width of the slots is selected so that with vertical positioning of the base (1) in an intersection of the slots concerned with a vertical plane perpendicularly to the base (2) and to a slot longitudinal direction a straight-line connecting line between a lower edge of the slot on a side of the base (1) and an upper edge of the slot on a opposite side of the base (1) stands at an angle to the normal on the base (1) which is between 0° and 45°, preferentially between 5° and 25°.

18. The sun protection device according to claim 4, characterized in that with vertical positioning of the base (1) the central axes of the bores follow a course so that with a parallel projection of the bores parallel to the plane of the base (1) on a vertical projection plane vertically to the base (1) the projections of the central axes are parallel to one another and that in the parallel projection a straight-line connecting line between a lower edge and the respective bore on a side of the base (1) and an upper edge of the bore (4, 10, 13) on an opposite side of the base (1) stands at an angle to the normal on the base (1) which is between 0° and 45°, preferentially between 5° and 25°.

19. The sun protection device according to claim 18, characterized in that at least some of the bores do not follow a parallel course.

20. The sun protection device according to claim 19, characterized in that the bores are arranged in rows and the central axes of the bores of each row each lie in a plane.

21. The sun protection device according to claim 4, characterized in that a diameter of the bores is so selected that with vertical positioning of the base (1) in a parallel projection of the bores parallel to the plane of the base on a vertical projection plane perpendicularly to the base (1) a straight-line connecting line between a lower edge of the respective bore on a side of the base (1) and an upper edge of the bore (4, 10, 13) on an opposite side of the base (1) stands at an angle to the normal on the base (1) which is between 0° and 45°, preferentially between 5° and 25°.

22. (canceled)

23. (canceled)

24. The sun protection device according to claim 1, characterized in that the side of the base (1) facing the sun has another colour than the side facing away from the sun.

25. The sun protection device according to claim 1, characterized in that the side of the base (1) facing away from the sun is formed in an IR-reflecting manner.

26. The sun protection device according to claim 1, characterized in that the side of the base (1) facing the sun and the side facing away from the sun are embodied in an IR-reflecting manner.

27. The sun protection device according to claim 1, characterized in that the base (1) with the openings (4, 10, 13) is arranged between a front-sided transparent cover and a rear-sided transparent cover, wherein the front-sided and/or the rear-sided transparent cover consist/s of an insulating glazing.

28. (canceled)

29. (canceled)

30. (canceled)

31. The sun protection device according to claim 27, characterized in that the front-sided and/or the rear-sided transparent cover/s is/are formed by a film.

32. The sun protection device according to claim 27, characterized in that the front-sided and/or the rear-sided transparent cover form/s a gas-tight hollow space which is filled with a noble gas.

33. The sun protection device according to claim 27, characterized in that the front-sided and/or the rear-sided transparent cover/s form/s a cavity which is back-ventilated towards the outside.

34. The sun protection device according to claim 27, characterized in that the front sided and/or the rear-sided transparent cover form/s a gas-tight hollow space which is evacuated and supported with spacers between the covers.

35. (canceled)

36. (canceled)

37. The sun protection device according to claim 32, characterized in that an inner side of the front-sided and/or the rear-sided transparent cover is provided with a low-emission layer, more preferably based on a non weather-stable soft coating.

38. The sun protection device according to claim 32 or 37, characterized in that the rear-sided transparent cover consists of a multiple insulating glazing wherein an inner side of an outermost pane of the insulating glazing is provided with a low-emission layer based on a non weather-stable soft coating.

39-44. (canceled)
